(19) United States
(12) Patent Application Publication
(10) Pub. No.: US 2018/0092401 A1
(43) Pub. Date: Apr. 5, 2018

(54) Device for assembling a battery element with the use end piece, with which it is associated, of an electronic cigarette

(71) Applicant: Thierry CAI, DRANCY (FR)

(72) Inventor: Thierry CAI, DRANCY (FR)

(21) Appl. No.: 15/566,101

(22) PCT Filed: Apr. 8, 2016
(86) PCT No.: PCT/FR2016/050819

§ 371 Date: Oct. 12, 2017

(30) Foreign Application Priority Data
Apr. 14, 2015 (FR) 15 53237

(51) Int. Cl. A24F 47/00; F16B 7/20; A24F 3/00

(52) U.S. Cl. CPC A24F 47/008; A24F 7/02; A24F 3/00; F16B 7/20

(57) ABSTRACT

The subject of the invention is a device for assembling an electronic cigarette (10) comprising a shell (15) containing electrical power supply means and a cartridge (12) that can be detached from the shell (15) of the electronic cigarette. The cartridge comprises at least one pin (14) projecting from the external wall of that end (13) of the cartridge (12) that is intended for assembling the cartridge (12) with the shell (15) of the cigarette, and an assembly ring (11) in which this end (13) becomes inserted, said ring (11) being placed inside the shell (15), at one end thereof, and configured to constitute the female socket of a bayonet assembly mechanism of which the end (13) of the pipe (12) forms the male part. The ring (11) comprises locking means (41, 42) which are configured to keep the pin (14) in a locking position (23) in the absence of user action when the cartridge (12) is being assembled with the shell (13).

### FIELD OF THE INVENTION

The invention relates to the general field of connection devices. It relates more particularly to means for connecting between the element of an electronic cigarette comprising the battery and the use end piece and comprising a reservoir containing the product prior to vaporization and the vaporization device producing the inhaled product.

### CONTEXT OF THE INVENTION

### Prior Art

In the field of electronic cigarettes, there are principally two types of object. A distinction is thus made between single-use electronic cigarettes in which all the component elements, principally the power supply body containing the battery, the element by means of which the user holds the electronic cigarette, and the use end piece containing the inhaled product, are packaged inseparably in a single case (disposable e-cigarettes) and reusable electronic cigarettes, which principally comprise two elements that may be separated: a body containing the power supply battery of the device and an end piece comprising a vaporizer device and an optionally refillable inhalation product reservoir, the end of the end piece forming the zone via which the user inhales the vaporized product, or use end.

Although more expensive to manufacture and to purchase than the disposable configuration, a configuration of this type advantageously allows long-term reuse of the body of the object and easy replacement of the use end piece.

Generally, the body of the object containing the battery is provided with means allowing commissioning and the recharging of the battery.

Nevertheless, the production of a disposable electronic cigarette inevitably poses a problem concerning the means to be set in place in order to achieve a detachable assembly of the two elements—body and end piece—constituting the electronic cigarette, and also a reliable electrical connection between the battery placed in the body of the cigarette and the device for vaporizing the inhaled product, incorporated in the end piece.

In devices known to date, the solution generally adopted consists in a fastening device in the form of a substantially cylindrical ring mounted on an end of the body of the cigarette and having a threading in its internal wall, said threading receiving the screwed-in end of the end piece opposite the use end, this end being threaded for that purpose. Assembly is then achieved by inserting the threaded end of the end piece in the end of the ring placed at the end of the body of the cigarette and by screwing the end of the end piece in the ring until the two elements are contiguous with one another.

An assembly method of this type, although slightly tricky for the user, offers the advantage of solid assembly of the two elements constituting the electronic cigarette.

However, given the dimensions of the ends of the two elements, it is not always easy to achieve the screwing of one into the other such that, in particular, if the two elements are not properly aligned when the end of the end piece is inserted into the ring, it is possible to incorrectly engage the screw thread of the end piece in the ring and to then perform a forced screwing action that leads to damage to the threading of the ring and thus to the body of the electronic cigarette. The body then has to be replaced.

Furthermore, even if the operation of screwing the end piece into the body is performed correctly, it can be envisaged that the handling of the electronic cigarette by the user will lead to unintentional partial unscrewing. This partial unscrewing may itself result in the electrical contacts located at the end of the body, inside the assembly ring, not being in close contact with the electrical contacts located at the end of the end piece inserted in the ring, such that a contact resistance is then introduced between the battery and the vaporizer device powered by said battery. This contact resistance gives rise to electrical losses that reduce battery autonomy and thus the functional autonomy of the electronic cigarette.

Furthermore, also, in the event of more significant unscrewing, the electrical contact between the battery and the vaporizer may be interrupted either permanently or, more perniciously, intermittently, which gives rise to erratic functioning of the vaporizer.

Given the problems that are at once ergonomic and functional, caused by the use of a screw-fastening end piece such as those known in the prior art, it is therefore necessary to find an alternate solution.

### PRESENTATION OF THE INVENTION

An object of the invention is principally to propose an alternate means that is more highly performing and more ergonomic, that can replace known fastening means designed to assemble together the body and the end piece of a device of the reusable electronic cigarette type.

To that end, a subject of the invention is a device for assembling an electronic cigarette comprising a body enclosing electrical power supply means and a use end piece that can be separated from the body of the electronic cigarette. According to the invention, the device comprises at least one pin projecting from the external wall of the end of the use end piece designed to assemble the end piece together with the body of the cigarette, and an assembly ring in which this end is inserted. Said ring is configured in order to be positioned in the body at one end of the latter. It is further configured so as to constitute the female socket of a bayonet-type assembly mechanism, the end of the conduit of which forms the male part. It further comprises locking means configured in the absence of action on the part of the user, to hold the pin in a locking position when the end piece is assembled together with the body.

The device according to the invention may furthermore comprise various features, it being possible for each to be considered alone or in combination.

Thus, according to a first feature, the assembly ring comprises at least one set of grooves made in the wall thereof, said set comprising an axial groove emerging on an annular groove of dimensions and geometry adapted to the dimensions and geometry of the pin of the end of the end piece. It further comprises locking means that interact with the set of grooves in order to make it possible to bring the pin into a locking position when the end of the end piece is inserted into the ring and to hold the pin in this locking position in the absence of action on the part of the user.

According to another feature, the annular groove constituting the set of grooves of the assembly ring is produced by a specific cutout of the wall of said ring that defines an element in the form of a planar annular elastic blade ending in a free end forming a stop at least partially closing off the groove so as to be located on the path of the pin when the latter traverses said groove.

According to another feature, the flexible blade constituting the annular groove is configured and arranged in the annular groove so as to provide, at the end of the groove, a locking zone designed to receive the pin when the latter traverses the groove over the entire length thereof, this locking zone being limited by the end of the flexible blade that forms a stop locking the pin in the locking zone.

According to another feature, the contour of the end of the elastic blade is configured in order that, given the form of the pin, the bending of the blade through the action of the thrust exerted by the latter when it traverses the groove toward its end in the direction of the locking zone is facilitated and the bending of the elastic blade is facilitated through the action of the thrust exerted by the pin when it tends to exit the locking zone in order to traverse the groove in the opposite direction is more difficult and requires greater force.

According to another feature, the assembly ring is produced from a material having flexibility characteristics that allow, in particular, its tight sleeving inside the body and having an elasticity enabling it to withstand, without damage, pressure and/or torsion stresses and to resume its initial form when the stresses cease.

According to another feature, the assembly ring is produced as a single element made from plastics, such as polyethylene.

According to another feature, the assembly ring has an external diameter defined such that its insertion in the body of the electronic cigarette constitutes a tight sleeving such that there is no clearance between the wall of the body of the cigarette and the wall of the assembly ring.

According to another feature, the assembly ring has an internal diameter defined such that the insertion of the end of the end piece in the ring constitutes a tight sleeving such that there is no clearance between the internal wall of the ring and the external wall of the end of the end piece.

According to another feature, the assembly ring comprises a set of additional striations designed to allow a thin stream of air to pass between the internal wall of the body and the external wall of the ring, from the end of the body on which the ring is mounted and the part of the body in which the battery is housed when the user inhales the vaporized product.

According to another feature, the annular groove constituting a set of grooves of the assembly ring is a single groove comprising at its end a notch forming a housing, the dimensions of which are defined in order that the pin of the end piece is housed therein when it has traversed the annular groove over the entire length thereof, the end of the end piece furthermore being pushed back outside the assembly ring by a spring arranged in the bottom of the ring.

According to another feature, the ring being equipped with two elastic electrical contacts, the spring may, for example, be constituted by the two electrical contacts that then ensure locking of the pin in the notch is constituted by said contacts.

According to a variant embodiment, the assembly ring is produced as two elements, a first element made from elastic plastics, such as polyethylene, and a second element made from metal from metal.

A further subject matter of the invention is a reusable electronic cigarette comprising an inhalation end piece assembled removably together with a body, characterized in that the end piece and the body are assembled by means of an assembly device according to the invention.

### DESCRIPTION OF THE FIGURES

The features and advantages of the invention will be more clearly ascertained by virtue of the following description, the description being based on a particular embodiment that does not limit the scope or the extent of the invention, and also on the appended figures, in which:

FIG. 1 shows schematic representations presenting the functioning principle of the invention;

FIGS. 2 and 3 show perspective schematic views of the assembly device according to the invention in accordance with a preferred embodiment;

FIG. 4 shows a lateral planar schematic view of the device according to the invention in the embodiment of FIGS. 2 and 3;

FIG. 5 shows a top schematic view of the device according to the invention in the embodiment of FIGS. 2 and 3;

FIG. 6 shows schematic views illustrating the functioning principle of the locking mechanism of the device according to the invention in the embodiment of FIGS. 2 and 3;

FIG. 7 is the illustration of an alternate form of the preceding embodiment;

FIGS. 8 and 9 are perspective and sectional illustrations of an alternative form of the embodiment illustrated in FIGS. 2 to 6.

It should be noted that the schematic representations constituting the various figures aim to enable the principle of the invention to be understood. To that end, the elements represented are not necessarily to the same scale.

It should also be noted that, unless otherwise required, one and the same element of the device is represented by the same reference in the various figures.

### DETAILED DESCRIPTION

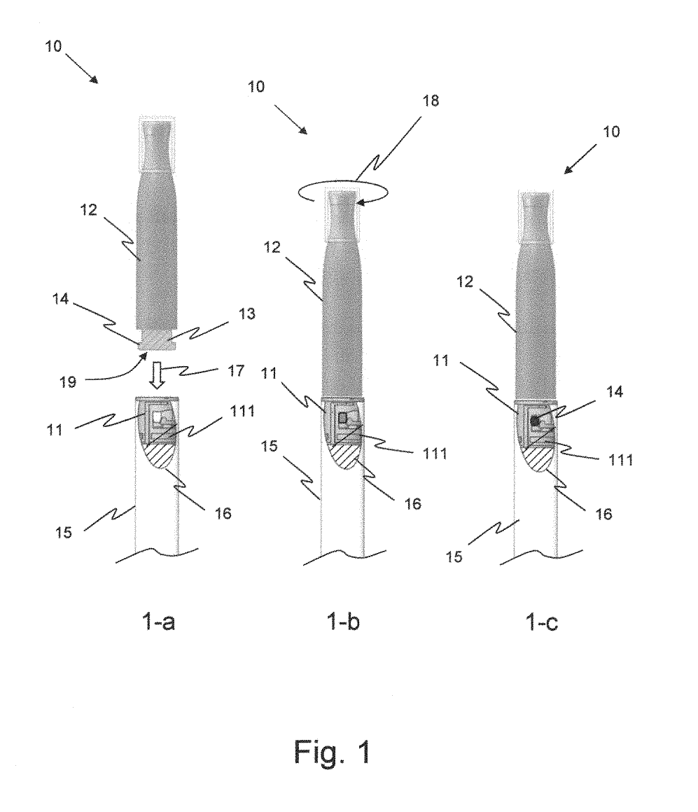

FIG. 1 shows a schematic view of an electronic cigarette 10 equipped with a fastening device according to the invention, with different steps in the operation of assembling the end piece 12 on the body 15 so as to form an entire electronic cigarette, as illustrated in view 1-c. According to the invention, the assembly device comprises a female element 11 allowing assembly of the end piece 12 of an electronic cigarette on the body 15 of the same cigarette.

As may be observed via the views in FIG. 1, the electronic cigarette in question comprises a body 15 (shown in part) in which the assembly element 11 according to the invention and also an end piece 12 comprising, in particular, a reservoir of product to be inhaled and also a vaporization device are housed.

The end piece 12 comprises an end 13, opposite the end 19 via which the user inhales the product to be inhaled, or use end, which has a structure adapted to the internal structure of the assembly element 11.

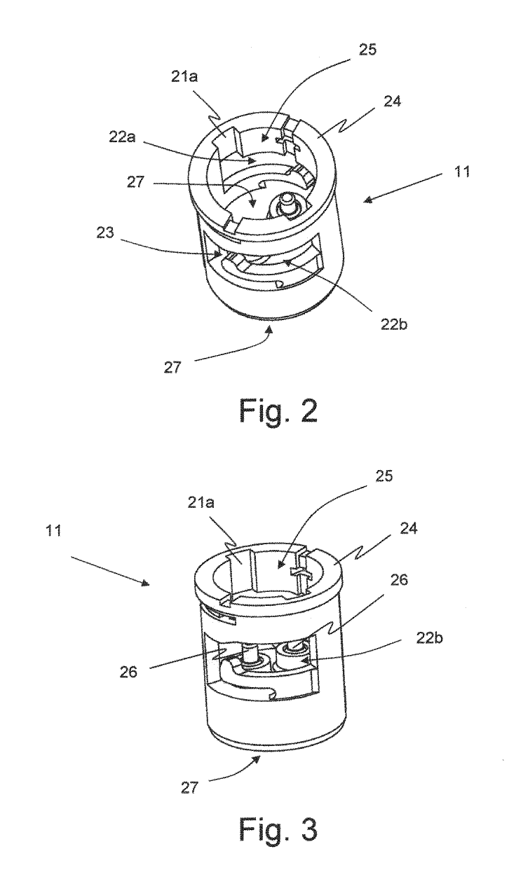

According to the invention, the assembly element 11, as illustrated in particular in FIGS. 2 and 3, has the general form of a cylindrical ring having an open end 25 through which the end 13 of the end piece 12 penetrates the ring 11 and a closed end 27 forming a bottom, through which are made passage orifices designed for the positioning of conductor studs 26 that make it possible to apply the voltage delivered by the battery, housed in the body 15, to contacts arranged on the face 19 of the end 13 of the end piece 12 in contact with the bottom 27 of the ring.

The end 25 is preferably provided with an edge 24 forming an external shoulder, which makes it possible in particular to hold the ring 11 in place at the end of the body 15 and prevents the latter from pushing into the body 15 upon insertion of the end piece 12. The edge 24 also makes it possible to provide an annular interface zone between the end piece 12 and the body 15, as illustrated in FIG. 1.

Apart from the shoulder 24, the assembly ring 11 has an external diameter defined such that its insertion in the body 15 of the electronic cigarette is a tight sleeving, such that there is no clearance between the wall of the body 15 and the wall of the assembly ring 11 of such a nature as to enable the latter to turn freely inside the body 15.

To reinforce gripping, the external face of the wall of the body 15 may comprise surface irregularities forming beads 111.

Similarly, the assembly ring 11 has an internal diameter defined such that the insertion of the end 13 of the end piece 12 in the ring 11 is also a tight sleeving, such that there is no clearance between the internal wall of the ring 11 and the external wall of the end 13 of the end piece 12. This absence of clearance advantageously on its own ensures the axial holding of the end 13 of the end piece 12 in the ring 11.

Furthermore, the assembly ring 11 has a height h defined so as to ensure that the end 13 of the end piece 12 is pushed in sufficiently into the body 15 to guarantee good resistance to bending of the assembled electronic cigarette 10, particularly in the zone of fastening of the end piece 12 on the body 15.

According to the invention, the wall of the assembly ring 11 has at least one longitudinal groove 21 emerging on an annular groove 22 in the manner of a female sleeve for a bayonet-type fastening mechanism.

Meanwhile, the end 13 of the end piece 12 that forms the male part of the fastening mechanism comprises at least one projecting pin 14 arranged on the external wall thereof, the form and the dimensions of which are adapted to dimensions of the axial and annular grooves in which it is to travel at the time of assembly of the electronic cigarette.

Preferably, the assembly ring 11 according to the invention has two sets of grooves 21a-22a and 21b-22b arranged so as to be diametrically opposed, as illustrated in FIG. 2, and allowing the insertion of an end piece 12, the end 13 of which comprises two diametrically opposed pins 14.

Next, as illustrated in FIG. 1, the assembly of the electronic cigarette according to the invention consists, in a first stage (cf. view 1-a), in inserting the end 13 of the end piece inside the assembly ring 11, causing the pin(s) 14 to penetrate the axial groove(s) of said ring as far as the bottom of the axial groove(s), then, in a second stage, in applying a rotational movement to the end piece 12, illustrated by the arrow 18 in view 1-b, which is designed to ensure that each pin 14 penetrates the corresponding annular groove, the groove 21a or 21b in FIG. 2, and traverses the entire groove until it occupies a position, marked by the return 23 in FIG. 2, in which it is held immobilized by an appropriate locking means.

Thus, the pin in question cannot traverse the annular groove 22 in which it is housed in the opposite direction without the user imparting a deliberate rotational movement to the end piece 12 in a direction that is the opposite of the direction of rotation of the arrow 18.

To that end, the assembly ring 11 according to the invention comprises an appropriate locking means, one preferred embodiment of which is described in the description below.

According to the invention, the lengths of the annular grooves 22 are principally defined by the number of sets of grooves 21-22 positioned on the wall of the assembly ring 11. Thus, according to the embodiment in question, the length of the grooves 22 may vary, provided it is sufficient to allow complete insertion of the pin 14 in said grooves.

Once each of the pins 14 of the end 13 of the end piece 12 is placed in an immobilized position, the electronic cigarette 10 in question is fully assembled and ready for use

From a structural standpoint, the assembly ring 11 is produced from a material having flexibility characteristics that, in particular, allow its tight sleeving inside the body 15.

The material used also has a degree of elasticity that enables it, without damage, to withstand the pressure and/or torsion stresses and to resume its initial form when the stresses cease. To that end, it may be produced preferably from plastics, such as polyethylene, for example.

The material used is also preferably an electrically insulating material.

FIGS. 2 to 5 illustrate a preferred embodiment of the assembly ring 11 according to the invention from a functional and structural standpoint. This preferred embodiment is, here, described in connection with an assembly mechanism adapted to an electronic-cigarette end piece 12 comprising two pins 14 at the end 13 thereof. The aim of this description is not to limit the device according to the invention to this single configuration and it is understood, here, that, in the case of this particular embodiment, the assembly ring 11 may, depending on the end piece 12 to which it is adapted, comprise a plurality of sets of grooves 21-22 arranged regularly in the wall of the ring 11 or, conversely, a single set of grooves.

As illustrated in FIGS. 2, 3 and 5, each of the axial grooves 21a and 21b is a single rectilinear groove made in the thickness of the wall of the ring, the dimensions and geometry of which are defined, given the geometry and the dimensions of the pin 14 designed to be inserted therein, such that the pin is able to slide without hindrance inside the groove when the end 13 of the end piece 12 is inserted in the assembly ring 11.

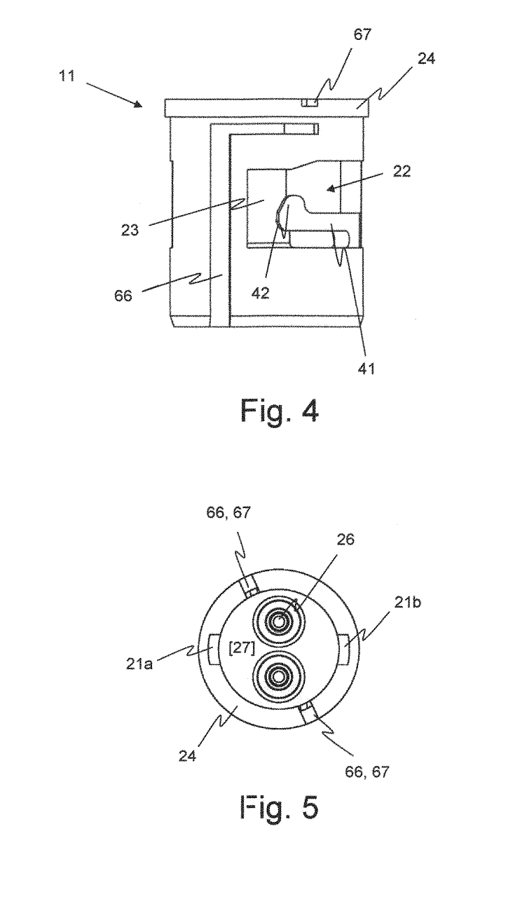

On the other hand, the annular grooves 22a and 22b are, meanwhile, formed by a specific cutout of the wall. This specific cutout, which can be clearly seen in FIG. 4, has the dual function of defining a wall in the form of an elastic blade 41, enabling the pin 14 to be guided, the latter sliding along the groove 22, bearing on said blade 28, when the end piece 12 is rotated, as illustrated in FIG. 1, and of a locking means designed to hold the pin 14 in an immobilized position when the annular groove 22a or 22b has traversed over the entire length thereof.

The elastic blade 41 thus formed has the form of a planar annular blade ending in a free end 42 forming a stop that locally closes off, at least partially, the path of the groove 22a or 22b.

According to the invention, the length of the flexible blade is less than the length of the groove 22. It is defined such that, after passing the stop 42, the groove has a space 23 that is sufficient for the pin 14 to be able to be accommodated therein.

Furthermore, the elastic blade 41 is arranged along the wall of the assembly ring 11 such that, once the end 13 of the end piece 12 is positioned in the assembly ring 11, the pin 14, positioned at the bottom of the axial groove 21, slides freely along the blade 41 owing to the end piece 12 being rotated, until it meets the stop 42, and such that, thereafter, when the rotational action is continued, the force exerted by the pin 14 against the stop 42 forces the blade 41 to bend so as to enable the pin 14 to continue its path in the groove 22 as far as the end 43 of the latter. The pin 14 is then positioned in the free space 23 such that it relaxes the pressure exerted on the end 42 of the blade 41 and the blade 41 resumes its rest position.

The contour of the end 42 of the elastic blade 41 is preferably configured in order that, given the form of the pin 14, the bending of the blade through the action of the thrust exerted by the pin when the end piece 12 is rotated in the direction enabling assembly of the end piece 12 on the body 15 is facilitated.

On the other hand, the contour of the end 42 is configured in order that bending of the blade through the action of the thrust exerted by the pin 14 when the end piece 12 is rotated in the direction allowing the separation of the end piece 12 from the body 15 (dismantling of the cigarette 10) is more difficult and requires greater force.

Thus, when the end piece 12 and the body 15 are assembled together, the displacement of the pin 14 in the annular groove 22 as far as the immobilization position 23 thereof takes place without significant resistance. On the other hand, when the end piece 12 and the body 15 are dismantled, the operator encounters a degree of resistance and has to apply a certain force in order that the action on the pin 14 resulting from the unscrewing of the end piece enables the latter to tilt the blade 41 and to engage in the groove 22.

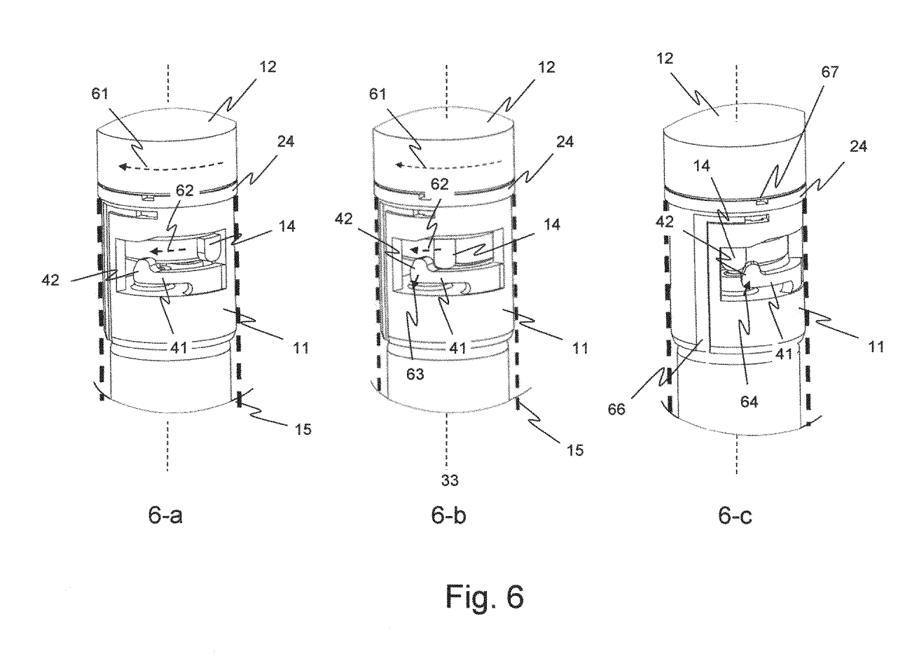

Owing to its flexibility and the form of its end 42, the blade 41 thus acts as a locking mechanism tending to hold the end piece 12 and the body 15 completely assembled together. Views 6-a to 6-c in FIG. 6 illustrate the functioning of the locking device thus constituted, as described in the above text.

View 6-a shows a partial view of the body 15 equipped with the assembly ring 11 according to the invention, into which the end 13 of the end piece 12, shown in only partial view, is inserted. The wall of the body 15 is, here, represented in bold broken lines. The arrows 61 and 62 illustrate, respectively, the movement imparted by the user on the end piece 12 in order to complete the assembly of the latter with the body 15 of the electronic cigarette and the rotational movement in which the pin 14 is subsequently entrained.

View 6-b shows a similar view, showing the instant when the pin 14, owing to its rotational movement, arrives in contact with the end 42 of the elastic blade 41 and imparts a bending movement thereto, this bending movement being shown by the arrow 63.

View 6-c shows a similar view, showing the instant when the pin arrives at the bottom of the groove 22 and is installed in the zone 23, where it is immobilized by the fact that, the end 42 of the elastic blade 41 no longer being subject to any pressure, the blade 41 returns to its rest position, this return being shown by the arrow 64.

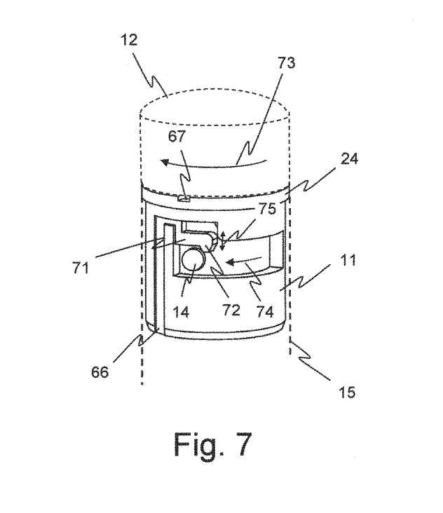

FIG. 7 shows an alternate embodiment of the embodiment described previously. As in the embodiment described previously, the locking mechanism that holds the pin 14 in the immobilized position is achieved by a particular structure of the annular groove 22, which has, as previously, an elastic blade 71 of the same type as the elastic blade 61, also ending in a stop 72 that is similar to the stop 62 in terms of structure and function. However, unlike the embodiment described previously, the elastic blade is, here, in the terminal position, at the bottom of the groove 22. It is, furthermore, arranged opposite the base of the annular groove 22 on which the pin 14 slides.

Nevertheless, these morphological differences do not substantially change the locking principle, the two embodiments corresponding to the same method.

Indeed, as previously, upon mounting of the end piece 12 on the body 15, the pin 14 slides freely in the groove 22, as illustrated by the arrow 74, until, on its path, it meets the stop 72, the latter obliging it to move away when it continues its path as far as the end of the groove 22. Then, after the passage of the pin 14, the stop 72 resumes its position and traps the pin 14 in the immobilization position 23 at the end of the groove. The arrow 75 shows the movement followed by the stop 72 upon functioning of the mechanism.

The pin 14 is then locked and, with it, the end piece 12, and unlocking does not occur until the user applies sufficient rotational force to the end piece in order for the pin 14 to be able to push the stop 72 back and to extract itself from the groove 22.

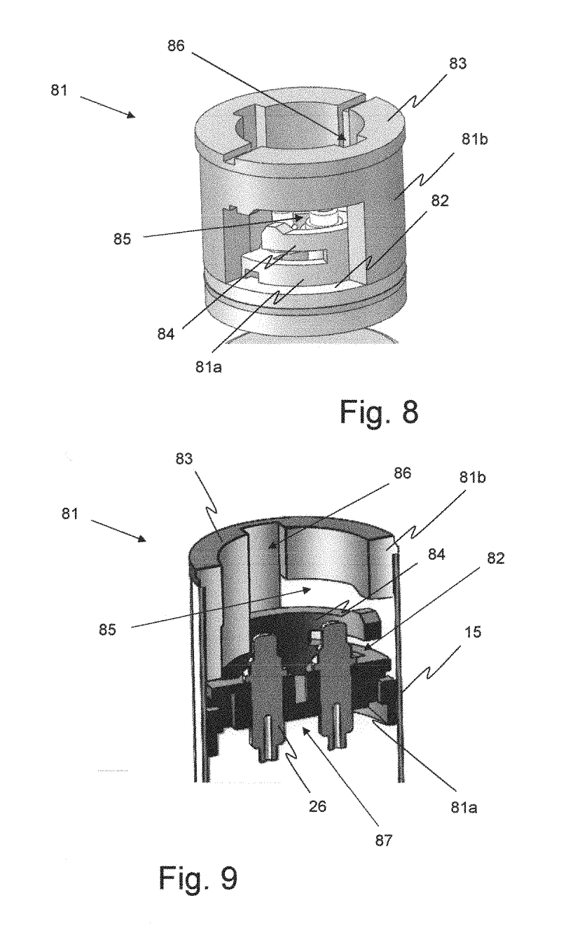

FIGS. 8 and 9 show an alternate embodiment of the assembly ring 11 according to the invention, as described previously.

This alternate embodiment shows the same general morphological features as the preceding embodiment illustrated in FIGS. 2 and 3 in particular. However, unlike the preceding embodiment, illustrated in FIGS. 2 to 6, the assembly ring 81 is, here, formed from two elements, a first element 81a and a second element 81b.

The first element 81a forms a tubular socket of cylindrical section having, as in the preceding embodiment 11, a closed end forming a bottom 87, through which passage orifices designed for the positioning of conductive pads 26 are made. The wall of the socket 81a has one or more cutouts distributed over its periphery and forming one or more elastic blades 84, similar to the elastic blades 41 of the ring 11, and also a circumferential bearing edge 82.

The second element 81b, meanwhile, forms a tubular structure configured in order to bear on the circumferential edge 82 and to form, together with the socket 81a, an element having an architecture similar to that of the monobloc assembly ring 11 described previously.

Thus, it constitutes, in particular, the lateral wall of the ring 81 when the two elements are assembled. To that end, the wall of the element 81b has one or more cutouts designed to be positioned opposite the one or more zones of the wall of the socket 81a forming the elastic blades 84, as illustrated in FIGS. 8 and 9, and to delimit as many annular grooves 85 fulfilling functions similar to the annular grooves 22 of the ring 11.

One or more longitudinal (axial) grooves 86 are, furthermore, made at the internal face of the wall of the element 81b. This or these groove or grooves are dimensioned and arranged on said wall such that they each communicate with a groove 85 and each allow the passage of a pin 14 of the use end piece as far as the entry of an annular groove 85.

Thus, the assembly of the elements 81a and 81b makes it possible to constitute a ring 81 having the same functionalities as the ring 11. The assembly ring 81 is inserted at the end of the body 15 of the electronic cigarette to allow the assembly of the use end piece 12 on the body 15. This two-element ring is, furthermore, advantageously easier to manufacture, by injection of plastics, in particular.

From the structural standpoint, however, the ring 81 has the advantage of being formed from two distinct elements 81a and 81b produced, depending on the aim sought, either from the same material, plastics having a degree of elasticity preferably allowing, in particular, the one or more elastic blades 84 to be produced, or in two different materials, plastics having a degree of elasticity for the socket 81a, in the wall of which the elastic blade(s) 84 is (are) produced, and a harder, more rigid material, for example metal, for the element 81b, which carries the axial groove 86 inside which the end of the use end piece 12 is inserted upon assembly of the end piece on the body 15.

The second element 81b has, at its free end, in other words its end that is not intended to enter into contact with the circumferential edge of the socket 81a, a border 83 designed, just like the edge 24 of the assembly ring 11, to bear on the end of the body 15. When the end piece 12 is mounted on the end of the body 15, the border 83 acts as a sole plate on which the end of the end piece 12 bears and which thus, in use, undergoes repeated compression stresses. Upon use of the electronic cigarette, only the circumferential edge of the border 83 remains visible in the manner of a ring placed between the body 15 and the end piece 12.

As a result, the use of an assembly ring formed from two distinct elements makes it possible advantageously to use a socket 81a in plastics chosen for the elasticity properties it will confer on the one or more blade(s) 84, for example in polyethylene, and an element 81b in metal, chosen for its greater hardness and for the esthetic property it is able to confer on the ring formed by the edge of the esthetic border 83 that enhances the general esthetic appearance of the assembly formed by the body 15 and the end piece 12.

The embodiments described by way of non-limiting examples in the preceding paragraphs make it possible, advantageously, to provide a simple locking means that does not require the placing of any additional component on the assembly ring 11.

It is, however, possible, obviously, to produce the locking mechanism differently, for example by producing an assembly ring 11 having, as in the preceding embodiment, two sets of grooves, each set comprising an axial groove and an annular groove, the annular groove, however, being a simple groove comprising, at its end, a notch forming a housing, the dimensions of which are defined in order that the pin 14 of the end piece 12 is accommodated therein when it has traversed the annular groove over the entire length thereof, the end 13 of the end piece 12 being, furthermore, pushed outside the ring 11 by an appropriate means, a spring arranged in the bottom of the ring, for example.

The spring may, for example, be formed by the two electrical contacts, such as the contacts 26 in FIG. 3, which may be sprung contacts or even simple elastic contacts. As in the case of the end of the elastic blade 41 of the preceding illustrative embodiment, the form of the notch is defined so as to achieve the desired locking function and, in particular, to render unintended unlocking difficult if not impossible.

It should be noted, generally, that insofar as the assembly ring 11 is inserted in the body 15 with no clearance being provided between the wall of the body 15 and the external wall of said device, the latter may comprise, irrespective of the embodiment in question, a set of additional striations designed to allow, when the user inhales the vaporized product, the passage of a thin stream of air between the internal wall of the body 15 and the external wall of the ring 11, from the end of the body on which the ring 11 is mounted and the part of the body 15 in which the battery is accommodated.

The passage of the stream of air is, in particular, necessary if the body 15 of the electronic cigarette in question comprises, in addition to the battery designed to supply electricity to the end piece, supplementary electronic means that make it possible to commission the battery only when the user inhales the inhalation product, these means generally comprising a pressure sensor sensitive to the occurrence of an airflow.

In such a configuration, the assembly ring 11 comprises a small groove running along its external wall in order to emerge at the open end 23 of the device. Such a groove is, in particular, shown in view 6-c (reference sign 66) in FIG. 6, this being a view showing that said groove runs over the external wall of the ring 11 from the closed end 25 and then traverses the wall of the ring and finishes its path along the internal wall, ending up in a groove 67 made at the surface of the shoulder 24 and emerging toward the exterior.

1. A device for assembling an electronic cigarette comprising:
a body enclosing electrical power supply means and a use end piece that can be separated from the body of the electronic cigarette,
wherein said device has at least one pin projecting from the external wall of an end of the use end piece designed to assemble the end piece together with the body of the cigarette, and
an assembly ring in which end is inserted, said ring being configured in order to be positioned in the body at one end of the latter, said assembly ring constituting the female socket of a bayonet-type assembly mechanism, the end said use end piece of which forms the male part; said ring further comprising locking meansconfigured, in the absence of action on the part of a user, to hold the pin in a locking position when the use end piece is assembled together with the body.

2. The device as claimed in claim 1, wherein said assembly ring further comprises at least one set of grooves made in the wall thereof, said set comprising an axial groove emerging on an annular groove of dimensions and geometry adapted to the dimensions and geometry of the pin of the end of the end piece, said ring further comprising locking means that interact with the set of grooves enabling the pin to be brought into a locking position when the end of the use end piece is inserted into the ring and to hold the pin in this locking position in the absence of action on the part of the user.

3. The device as claimed in claim 2, wherein the annular groove constituting a set of grooves of the assembly ring is produced by a specific cutout of the wall of said ring that defines an element in the form of a planar annular flexible blade ending in a free end forming a stop closing off the groove locally, at least partially, so as to be located on the path of the pin when the latter traverses the groove.

4. The device as claimed in claim 3, wherein the flexible blade is configured and arranged in the annular groove so as to provide, at the end of the groove, a locking zone designed to receive the pin when the latter traverses the groove over the entire length thereof, the locking zone being limited by the free end of the flexible blade that forms a stop locking the pin in the locking zone.

5. The device as claimed in claim 4, wherein the contour of the free end of the elastic blade is configured, given the form of the pin, such that the bending of the blade through the action of a thrust exerted by the latter when it traverses the groove toward its end in the direction of the locking zone is facilitated, and the bending of the elastic blade is facilitated through the action of the thrust exerted by the pin when it tends to exit the locking zone in order to traverse the groove in the opposite direction is more difficult and requires greater force.

6. The device as claimed in claim 1, wherein the assembly ring has an external diameter defined such that the ring's insertion in the body of the electronic cigarette constitutes a tight sleeving such that there is no clearance between the wall of the body and the wall of the assembly ring.

7. The device as claimed in claim 1, wherein the assembly ring has an internal diameter defined such that the insertion of the end of the end piece in the ring constitutes a tight sleeving such that there is no clearance between the internal wall of the ring and the external wall of the end of the end piece.

8. The device as claimed in claim 1, wherein the assembly ring comprises a set of additional striations allowing a thin stream of air to pass between the internal wall of the body and the external wall of the ring, from the end of the body on which the ring is mounted and the part of the body in which the battery is housed when the user inhales the vaporized product.

9. The device as claimed in claim 1, wherein the annular groove constituting a set of grooves of the assembly ring is a single groove comprising at its end a notch forming a housing, the dimensions of which are defined such that the pin of the end piece is housed therein when it has traversed the annular groove over the entire length thereof, the end of the end piece further being pushed back outside the assembly ring by a spring arranged in the bottom of the ring.

10. The device as claimed in claim 9, wherein, the ring is equipped with two springs constituted by two elastic electrical contacts, the springs locking the pin in the notch is constituted by said contacts.

11. The device as claimed in claim 1, wherein the assembly ring is produced from a material having flexibility characteristics that allow its tight sleeving inside the body and having sufficient elasticity to enable said to withstand, without damage, pressure and/or torsion stresses and to resume its initial form when the stresses cease.

12. The device as claimed in claim 11, wherein the assembly ring is produced from plastics.

13. The device as claimed in claim 1, wherein the assembly ring comprises two elements:
a first element forming a tubular socket of cylindrical section with a closed end forming a bottom, through which are made passage orifices designed for the positioning of conductor studs, the wall of the socket having one or more cutouts distributed over its periphery and forming one or more elastic blades, and also a circumferential supporting edge;
a second element, forming a tubular structure, configured in order to bear on the circumferential edge of the first element, the wall of the second element having one or more cutouts designed to be positioned opposite the one or more zones of the wall of the socket that forms the elastic blades and to delimit as many annular grooves;
the second element further having one or more axial grooves made in the internal face of its wall, said grooves being dimensioned and arranged on said wall such that they each communicate with an annular groove so as to allow the passage of a pin of the use end piece as far as the entry of an annular groove.

14. The device as claimed in claim 13, wherein the assembly ring comprises the two elements produced from the same plastics, having sufficient elasticity to form an elastic blade.

15. The device as claimed in claim 13, wherein the assembly ring comprises the two elements made from two different materials:
the first element being made from plastics having sufficient elasticity to form an elastic blade;
the second element being produced from a rigid material, for example from metal.

16. A reusable electronic cigarette comprising:
said inhalation use end piece assembled removably together with said body, both constructed according to claim 1.
